(19) United States
(12) Patent Application Publication
(10) Pub. No.: US 2026/0235557 A1
(43) Pub. Date: Aug. 13, 2026

(54) MAGNETOSTRICTIVE ULTRASONIC TRANSDUCERS, MAGNET ASSEMBLIES, AND RELATED MEASUREMENT SYSTEMS

(71) Applicant: Battelle Energy Alliance, LLC, Idaho Falls, ID (US)

(72) Inventors: Bibo Zhong, Idaho Falls, ID (US); Joshua E. Daw, Idaho Falls, ID (US); Mustafa S. Cetiner, Cambridge, MA (US)

(21) Appl. No.: 19/535,903

(22) Filed: Feb. 10, 2026

Related U.S. Application Data
(60) Provisional application No. 63/758,277, filed on Feb. 13, 2025.

(51) Int. Cl. G01N 29/24

(52) U.S. Cl. CPC G01N 29/2412

(57) ABSTRACT

A magnetostrictive ultrasonic transducer is disclosed. The magnetostrictive ultrasonic transducer includes a radiofrequency coil and a magnet assembly. The magnet assembly includes a magnet element and a magnetostrictive element. The magnet element includes a first end and a second end. The second end is configured to be coupled to a wave receiving structure. The magnetostrictive element extends around a portion of the magnet element, offset from the second end, and positioned within the radiofrequency coil. The magnetostrictive element is joined to the magnet element and includes tines extending at an acute angle relative to an axial direction of an axis of the magnet assembly.

### CROSS-REFERENCE TO RELATED APPLICATIONS

This application claims the benefit under 35 U.S.C. § 119(e) of U.S. Provisional Patent Application Ser. No. 63/758,277, filed Feb. 13, 2025, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to measurement systems for extreme environments, and more specifically to magnetostrictive ultrasonic transducers.

### BACKGROUND

Operation of measurement systems in extreme environments, such as high-temperature and high-radiation nuclear environments, presents complications with accurate measurements for properties (e.g., temperature, level, density, and viscosity) of liquids.

### BRIEF SUMMARY

In various embodiments, the disclosure provides a magnetostrictive ultrasonic transducer. The magnetostrictive ultrasonic transducer includes a radiofrequency coil and a magnet assembly adjacent to the radiofrequency coil. The magnet assembly includes a magnet element and a magnetostrictive element. The magnet element includes a first end and a second end. The second end configured to be coupled to a wave receiving structure. The magnetostrictive element extends around a portion of the magnet element, offset from the second end, and positioned within the radiofrequency coil. The magnetostrictive element is joined to the magnet element and including tines extending at an acute angle relative to a longitudinal direction of the magnet assembly.

In various embodiments, the disclosure provides a magnet assembly for a magnetostrictive ultrasonic transducer. The magnet assembly includes a waveguide, a magnet element, and a magnetostrictive element. The magnet element is joined to and extends from the waveguide. The magnetostrictive element extends around a portion of the magnet element, offset from the waveguide. The magnetostrictive element is joined to the magnet element and including tines extending at an acute angle relative to a longitudinal direction of the magnet element.

In various embodiments, the disclosure provides a measurement system. The measurement system includes a magnetostrictive ultrasonic transducer and a controller. The magnetostrictive ultrasonic transducer includes a coil assembly and a magnet assembly. The coil assembly is configured to transmit and receive signals. The coil assembly includes a coil bobbin including a bore formed therein and a radiofrequency coil on the coil bobbin. A magnet assembly includes a magnet element and a magnetostrictive element. The magnet element includes a first end and a second end, the second end couplable to a wave receiving structure. The magnetostrictive element extends around a portion of the magnet element, offset from the second end, and positioned within the bore of the coil bobbin. The magnetostrictive element includes tines extending at an acute angle relative to a longitudinal direction of the magnet assembly. The controller is configured to send input signals to the radiofrequency coil to cause the magnetostrictive ultrasonic transducer to generate one or more ultrasonic waves, receive output signals from the magnetostrictive ultrasonic transducer, and process the output signals to determine one or more properties of a fluid or structure.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is a schematic illustration of a measurement system, in accordance with one or more embodiments;

FIG. 2 is an exploded view of a transducer of the measurement system of FIG. 1, in accordance with one or more embodiments;

FIG. 3 is a perspective view of a coil assembly of the transducer of FIG. 2, in accordance with one or more embodiments;

FIG. 4 is an end view of a coil assembly of the transducer of FIG. 2, in accordance with one or more embodiments;

FIG. 5 is a perspective view of a magnet assembly of the transducer of FIG. 2, in accordance with one or more embodiments;

FIG. 6 is a perspective view of a guide portion of the wave receiving structure of FIG. 5, in accordance with one or more embodiments;

FIG. 7 is a detailed perspective view of a portion of the magnet assembly of FIG. 5, in accordance with one or more embodiments;

FIG. 8 is a detailed perspective view of a patch of the magnet assembly of FIG. 5, in accordance with one or more embodiments;

FIG. 9 is a detailed view of the patch of FIG. 8 prior to folding or rolling the patch into a final form, in accordance with one or more embodiments;

FIG. 10 is a detailed view of another configuration of the patch prior to folding or rolling the patch into a final form, in accordance with one or more embodiments;

FIG. 11 is a detailed view of another configuration of the patch prior to folding or rolling the patch into a final form, in accordance with one or more embodiments; and

FIG. 12 is a detailed view of another configuration of the patch prior to folding or rolling the patch into a final form, in accordance with one or more embodiments.

### DETAILED DESCRIPTION

Magnetostrictive ultrasonic transducers are known for their tolerance to high-temperature, high-pressure, and high-radiation nuclear environments. However, generating ultrasonic waves using a conventional magnetostrictive transducer uses a first magnetic element for generating a biasing magnetic field and a second element for generating longitudinal and torsional waves, each requiring electrical leads thereto.

In various embodiments, the disclosure relates to a measurement system including a magnetostrictive ultrasonic transducer. The magnetostrictive ultrasonic transducer includes a magnet assembly configured to provide a biasing magnetic field and, responsive to a magnetic field generated by an RF coil, generate both longitudinal and torsional waves. The magnet assembly includes a magnet element and a magnetostrictive element, which may be a patch formed via one or more layers of a sheet, plating, a coating, or an overmold polymer composite containing magnetostrictive particles or fibers without limitation (hereinafter referred to interchangeably as a “patch” or “magnetostrictive element”) surrounding a portion of the magnetic element. The patch includes tines, which may produce the torsional waves. The measurement system produces the longitudinal waves and torsional waves substantially simultaneously. The magnet assembly may simplify the structure of the magnetostrictive ultrasonic transducer, such as by removing a need for another coil or another magnet, may reduce the number of lead wires used in the measurement system, and may reduce a size of the magnetostrictive ultrasonic transducer. Further, by utilizing a magnet with different field orientations, the magnet assembly may be utilized to excite different wave modes, such as flexural or surface propagating modes. The magnet element is coupled (e.g., permanently or temporarily) to a wave receiving structure. The wave receiving structure may be part of the magnet assembly (e.g., a waveguide, without limitation) or may be a structure of interest (e.g., a structure to be integrated, such as a faceplate or a wear plate, without limitation). The measurement system may be used, for example, to measure a liquid level, temperature, pressure, etc.

The illustrations presented herein are not actual views of any system, device, structure, or any component thereof, but are merely idealized representations, which are employed to describe embodiments of the present invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any system, device, or structure, when utilized in a conventional manner. Furthermore, these terms may refer to an orientation of elements of any system, device, or structure, as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter or for a range of values of a given parameter is inclusive of the stated value or range of values and has the meaning dictated by the context (e.g., it includes the degree of error associated with measurement of the given parameter or range of values for the given parameter, as well as variations resulting from manufacturing tolerances, etc.). For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

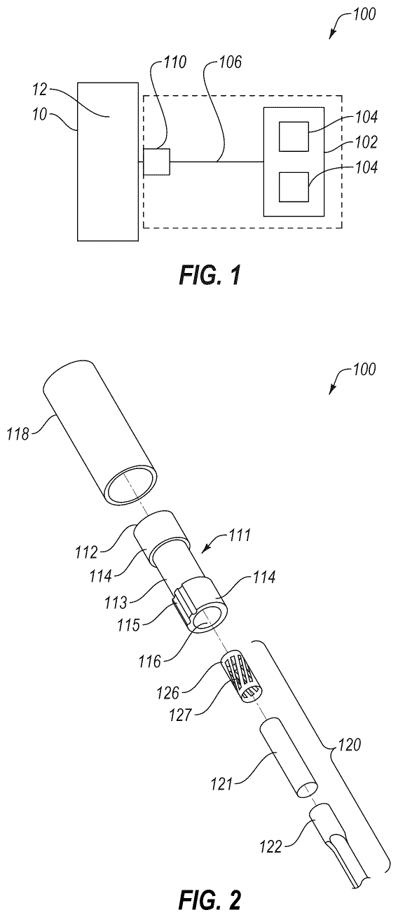

FIG. 1 is a schematic illustration of a measurement system 100, in accordance with one or more embodiments. Referring to FIG. 1, the measurement system 100 may be configured to measure properties (e.g., temperature, level, density, and viscosity, without limitation) of a fluid 12 in a fluid vessel 10, detect defects in a sample, measure material properties (e.g., stiffness and elastic moduli, without limitation), or function as an actuator (e.g., for ultrasonic cleaning, switch actuation, and fluid atomization, without limitation). The measurement system 100 may be used to measure multiple properties of the fluid 12 substantially simultaneously. The measurement system 100 may be used, for example, to measure both temperature and liquid level of the fluid 12. The fluid vessel 10 and the fluid 12 may be located within an extreme environment, such as in a high-temperature and high-radiation nuclear environment. The measurement system 100 may, for example, be integrated in the energy system of U.S. Provisional Application No. 63/705,346, titled “A FLUID PROPERTY MEASUREMENT SYSTEM INCLUDING A WAVEGUIDE, AND RELATED ENERGY SYSTEMS AND METHODS OF MEASURING PROPERTIES OF A FLUID,” and filed on Oct. 9, 2024, which is incorporated herein by reference, and filed as U.S. patent application Ser. No. 19/352,900 filed on Oct. 8, 2025, other nuclear reactor systems, cooling systems, petroleum systems, and other similar systems. The fluid 12 may be a molten salt, light water, petroleum, or other high-temperature fluids. Various components of the measurement system 100 may also be utilized for industrial sonic cleaning and/or welding systems.

In various embodiments, the measurement system 100 includes a controller 102, a magnetostrictive ultrasonic transducer 110, and lead wires 106 electronically connecting the controller 102 to the magnetostrictive ultrasonic transducer 110. The controller 102 is configured to send input signals (e.g., a square wave or short input, without limitation) to cause the magnetostrictive ultrasonic transducer 110 to generate longitudinal and/or torsional waves. The controller 102 is configured to receive output signals from the magnetostrictive ultrasonic transducer 110 and process the output signals to determine one or more properties (e.g., temperature, level, density, and viscosity) of the fluid 12 in the fluid vessel 10.

In various embodiments, the controller 102 includes one or more processors 103 and memory 104. The memory 104 includes instructions that, when executed by the one or more processors 103, enable the one or more processors 103 to: cause input signals to be sent to the magnetostrictive ultrasonic transducer 110; and receive and process the output signals from the magnetostrictive ultrasonic transducer 110. The controller 102 and the lead wires 106 may be commercially available from numerous sources.

The magnetostrictive ultrasonic transducer 110 may be positioned adjacent to or partially inserted into the fluid vessel 10.

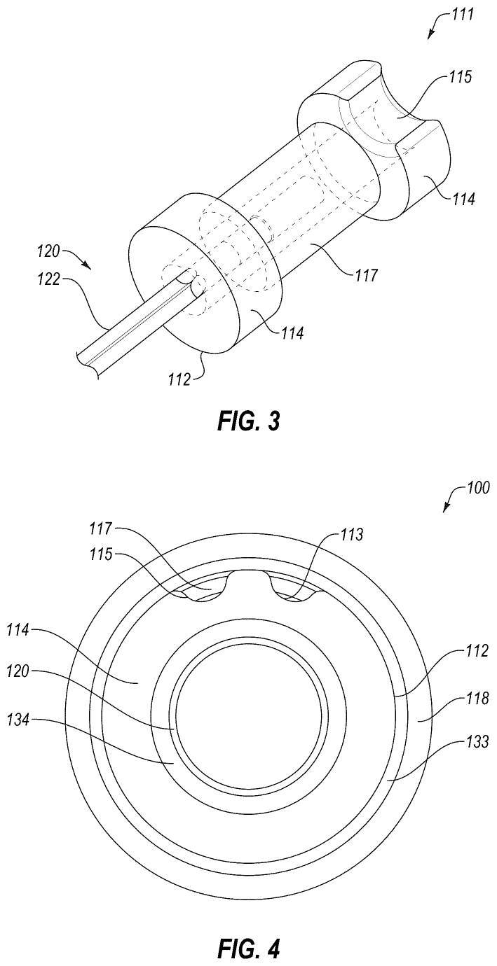

FIG. 2 is an exploded view of the magnetostrictive ultrasonic transducer 110 of the measurement system 100 of FIG. 1, in accordance with one or more embodiments. FIG. 3 is a perspective view of a coil assembly 111 of the magnetostrictive ultrasonic transducer 110 of FIG. 2, in accordance with one or more embodiments. FIG. 4 is an end view of the coil assembly of the transducer of FIG. 2, in accordance with one or more embodiments. Referring to FIG. 2-4, the magnetostrictive ultrasonic transducer 110 includes the coil assembly 111, a casing 118, and a magnet assembly 120.

The coil assembly 111 includes a radiofrequency (RF) coil 117 and a coil bobbin 112. The RF coil 117 is configured to transmit and receive signals to and from the controller 102 via the lead wires 106 (refer to FIG. 1), the RF coil 117 electronically connected to the lead wires 106 (directly or indirectly). Other coils, such as a DC biasing coil, are not included (e.g., present) in this coil assembly 111. In various embodiments, the RF coil 117 is the only coil present in the magnetostrictive ultrasonic transducer 110. In various embodiments, the magnetostrictive ultrasonic transducer 110 includes two RF coils 117, a first coil configured as a transmitter and a second coil configured as a receiver; however, other coils, such as a DC biasing coil, are not included (e.g., present) with the two RF coils 117. In other various embodiments, a second biasing coil is used with a differently oriented permanent magnet to impose a second, axial, field to add another, different, ultrasonic wave mode.

The coil bobbin 112 is configured to receive the RF coil 117 thereon. In various embodiments, the coil bobbin 112 includes a coil mount 113, coil formers 114, one or more routing features 115, and a bore 116. The coil mount 113 may include a cylindrical shape (e.g., a hollow circular cylinder, without limitation). The coil formers 114 each include a flange positioned at each end of the coil mount 113, protruding radially outward relative to the coil mount 113.

The coil formers 114 may also include cylindrical shapes (e.g., hollow circular cylinder shapes, without limitation). The one or more routing features 115 are formed in one of the coil formers 114. The one or more routing features 115 are configured to receive an end of lead wires 106 therein to facilitate connecting the end of the lead wires 106 to the RF coil 117. Each of the one or more routing features 115 defines a channel extending axially across the coil former 114 (e.g., a slot or an internal passage extending through the flange, without limitation). The coil formers 114 may be formed from a ceramic material.

The bore 116 is formed in the coil bobbin 112 and extends at least partially into the coil mount 113. The bore 116 is sized to receive a portion of the magnet assembly 120 therein.

The coil bobbin 112 may be formed of conventional materials, such as a plastic material (e.g., polytetrafluoroethylene (PTFE)or polyether ether ketone (PEEK), without limitation), a ceramic material (e.g., Macor or alumina, without limitation), a non-ferrous metal material (e.g., aluminum or titanium, without limitation), or combinations thereof.

The casing 118 is configured to receive the coil assembly 111, including the RF coil 117 and the coil bobbin 112, therein along with a portion of the magnet assembly 120 that is received within the bore 116. The casing 118 includes a hollow shape (e.g., a hollow right circular cylinder, without limitation). In various embodiments, an inner diameter of the casing 118 is larger than an outer diameter of the RF coil 117 and the coil formers 114, defining a gap 133 therebetween (refer to FIG. 4). The fit between the inner diameter of the casing 118 and the outer diameter of the RF coil 117 and the coil formers 114 may be maintained by centering features and/or a fill material (e.g., epoxy or cement, without limitation). In other various embodiments, the fit between the inner diameter of the casing 118 and the outer diameter of the RF coil 117 and the coil formers 114 is a tight fit (e.g., an interference fit, without limitation). The casing 118 may be formed of and include stainless steel, aluminum, a nickel-chromium alloy (e.g., an INCONEL® alloy, without limitation), titanium, a titanium alloy, or other alloy that maintains its structural integrity at the operating temperature and pressure of the fluid 12 in the fluid vessel 10.

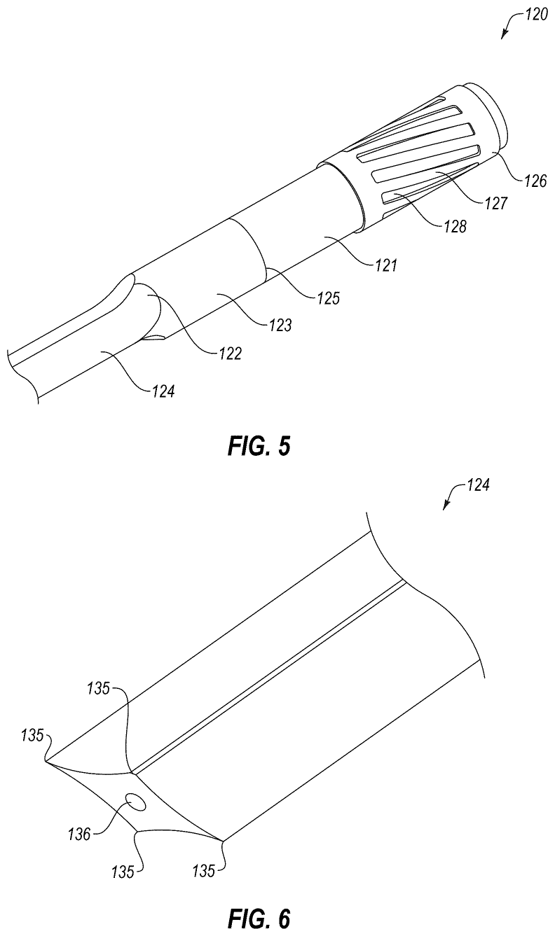

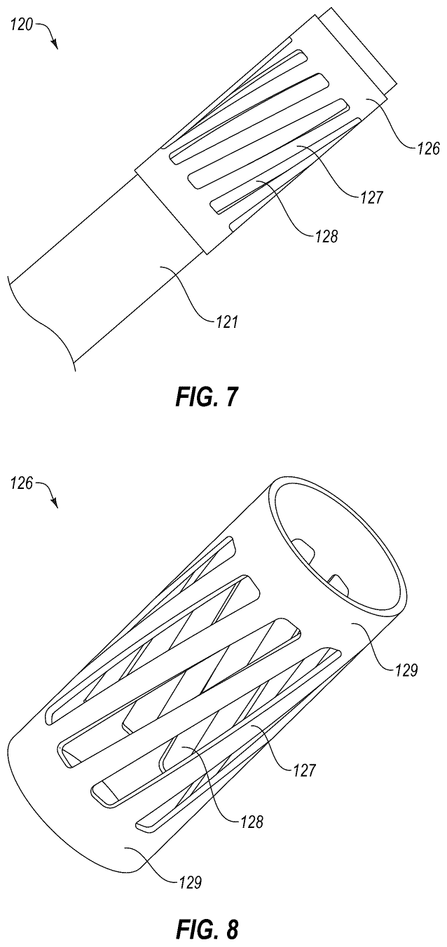

FIG. 5 is a perspective view of the magnet assembly 120 of the magnetostrictive ultrasonic transducer 110 of FIG. 2, in accordance with one or more embodiments. FIG. 6 is a perspective view of a guide portion of the wave receiving structure 122 of FIG. 5, in accordance with one or more embodiments. FIG. 7 is a detailed perspective view of a portion of the magnet assembly 120 of FIG. 5, in accordance with one or more embodiments. FIG. 8 is a detailed perspective view of a patch 126 of the magnet assembly 120 of FIG. 5, in accordance with one or more embodiments. Referring to FIGS. 2 and 5-7, in various embodiments, the magnet assembly 120 includes a magnet element 121 and the patch 126. The magnet element 121 and the patch 126 may be joined together as an integral component via a metal fusion process (e.g., welding or brazing, without limitation). The magnet assembly 120 may be coupled to a wave receiving structure 122. The magnet element 121 may be permanently coupled to the wave receiving structure 122 (e.g., via a metal fusion process, such as by welding or brazing, without limitation) or may be temporarily coupled to the wave receiving structure 122 (e.g., via a pressure coupling, without limitation). In various embodiments, the magnet assembly 120 includes the wave receiving structure 122 configured to propagate waves generated by the magnet assembly 120. In other various embodiments, the wave receiving structure 122 is a structure of interest (e.g., a structure to be interrogated by the measurement system, such as a faceplate or a wear plate, without limitation).

In various embodiments, the wave receiving structure 122 defines a waveguide including a connection portion 123 and a guide portion 124. The connection portion 123 is joined to the magnet element 121 via a joint 125. The joint 125 may be formed via a metal fusion process (e.g., welding or brazing, without limitation). The connection portion 123 may include a cylindrical shape (e.g., a right circular cylinder, without limitation) and may have a diameter that substantially matches (e.g., is substantially similar to) a diameter of the magnet element 121.

The guide portion 124 may include geometric features configured to optimize the operation of the magnetostrictive ultrasonic transducer 110. For example, the geometric features of the guide portion 124 may define the inertial sensitivity of the waveguide 122. A particular inertial sensitivity may be desired for operation of the magnetostrictive ultrasonic transducer 110 in a given environment or within certain environmental conditions. The guide portion 124 may include geometric features for the waveguide 122 to have an inertial sensitivity that about the particular inertial sensitivity desired for the particular operational use thereof.

Referring to FIG. 6, in various embodiments, the guide portion 124 includes a cusped diamond shape in cross-section. The cusped diamond shape may include curved edges that terminate in points 135 on opposing edges of the guide portion 124. The points 135 may include acute cross-sectional angles and extend the length of the guide portion 124. The guide portion 124 may include a longitudinal cavity 136 formed therein that extends through at least a portion of the guide portion 124. Dimensions of the longitudinal cavity 136 may affect the inertial properties of the waveguide. The size and shape of the longitudinal cavity relative to the guide portion 124 may be adjusted to change the inertial sensitivity of the waveguide. The guide portion 124 may include other geometric features and configurations, such as any waveguide configuration described in U.S. Provisional Application No. 63/705,346 and other configurations known in the art.

The magnet element 121 includes a structure chosen from among a permanent metallic magnet and a metal-coated magnet. The metallic magnet or metal coat includes a metal bondable (e.g., via a weld or a braze, without limitation) with a metal material of the wave receiving structure 122 and a metal material of the patch 126. The magnet element 121 may be formed of and/or include a permanent magnet, such as an alnico magnet (a magnet formed of an iron alloy primarily composed of aluminum (Al), nickel (Ni), and cobalt (Co)), a samarium-cobalt magnet, or a neodymium iron boron (NdFeB) magnet, or a ferrite magnet, without limitation. If the magnet element 121 includes a metal coat, the metal coat may be applied to the magnet element 121 by a deposition process (e.g., physical vapor deposition, such as sputtering, chemical vapor deposition, or atomic layer deposition, without limitation). The magnet element 121 may include a cylindrical shape (e.g., a right circular cylinder, without limitation). The magnet element 121 is joined to an end of the connection portion 123 distal to the guide portion 124 and extends axially therefrom.

The patch 126 extends around a portion of the magnet element 121 and is joined to the magnet element 121 via a metal fusion process (e.g., welding or brazing, without limitation), a structural adhesive lamination, coating (e.g., a thermal spray or a cold spray without limitation), plating (electro/electroless plating, without limitation), or an overmold, without limitation. The patch 126 is a magnetostrictive element formed of and includes a magnetostrictive alloy. The patch 126 may be one or more layers of a sheet, plating, coating, an additively manufactured body, or an overmold polymer composite containing magnetostrictive particles or fibers, without limitation. The patch 126 may be formed by an additive manufacturing process, may be machined to a final shape before or after being joined to the magnet element 121, may be formed directly on the magnet element 121, or may be formed utilizing combinations thereof. In various embodiments, the patch 126 is positioned on (e.g., connected, formed on, or joined to, without limitation) the magnet element 121 adjacent to a first end distal to a second end that will be or is coupled to the wave receiving structure 122 and offset from the second end/wave receiving structure 122 in a longitudinal direction of the magnet element 121. In various embodiments, the patch 126 is positioned closer to the second end of the magnet element 121 distal to the wave receiving structure 122 than the first end coupled to the wave receiving structure 122.

In an assembled state, the RF coil 117 may be centered over a center of the patch 126 (e.g., a center of the RF coil 117 in the axial direction aligns with a center of the patch 126 in the axial direction, without limitation) with the magnet element 121 and the patch 126 received within the bore 116 of the coil bobbin 112. A portion of the wave receiving structure (e.g., the guide portion 124 of the waveguide, without limitation) may axially protrude from the coil assembly 111. In various embodiments, the diameter of the bore 116 is larger than the outer dimensions of the magnet element 121 and the patch 126 defining a gap 134.

Referring to FIG. 8, the patch 126 includes magnetic flux guides 129 at each end and tines 127 extending axially between the magnetic flux guides 129. The tines 127 are separated by inner slots 128. The tines 127 are at an angle 141 relative to an axial direction defined by an axis 140 of the patch 126 and the magnet element 121. The angle 141 of the tines 127 may be an acute angle relative to the axial direction of the magnetic flux guides 129. In various embodiments, the angle 141 is one of from about 15 degrees to about 50 degrees, from about 30 degrees to about 45 degrees, or about 45 degrees. The tines 127 may include a width wider than the inner slots 128 or narrower than the inner slots 128 depending on an application of the magnetostrictive ultrasonic transducer 110. The inner slots 128 may be formed by conventional techniques, such as by laser cutting. FIG. 8 illustrates the patch 126 after folding or rolling a material of the patch 126 into a final form.

In various embodiments, the patch 126 includes a hollow structure chosen from among a hollow right prism and a hollow right circular cylinder.

The magnet assembly 120 is configured to provide a biasing magnetic field and, responsive to the magnetic field generated by the RF coil 117, generate longitudinal and torsional waves. The longitudinal waves may be generated by the wave receiving structure 122 (e.g., the waveguide, without limitation) and the torsional waves may be generated by the tines 127. In particular, interaction of the longitudinal waves with the tines 127, which are angled relative to the longitudinal direction of the magnet assembly 120, may induce a shearing effect on the longitudinal wave to produce the torsional waves. The biasing magnetic field may enhance the energy of the wave receiving structure 122.

The combination of the wave receiving structure 122 (e.g., the waveguide, without limitation), the magnet element 121, and the patch 126 in the magnet assembly 120 enable the production of the biasing magnetic field along with the longitudinal and torsional waves, and thus, is self-biasing and is without the presence of another coil (e.g., a DC coil) for biasing the magnetic field. The self-biasing of the magnetostrictive ultrasonic transducer 110 that is without the presence of another coil may simplify the structure of the magnetostrictive ultrasonic transducer 110, reduce the number of lead wires 106 present in the measurement system 100, and reduce an overall size (e.g., dimensions) of the magnetostrictive ultrasonic transducer 110. In various embodiments, the outer diameter of the magnetostrictive ultrasonic transducer 110/casing 118 is from about 1.0 inch to about 1.5 inches. Since the magnet assembly 120 according to embodiments of the disclosure lacks another coil, the measurement system 100 includes fewer external components relative to a conventional magnetostrictive transducer.

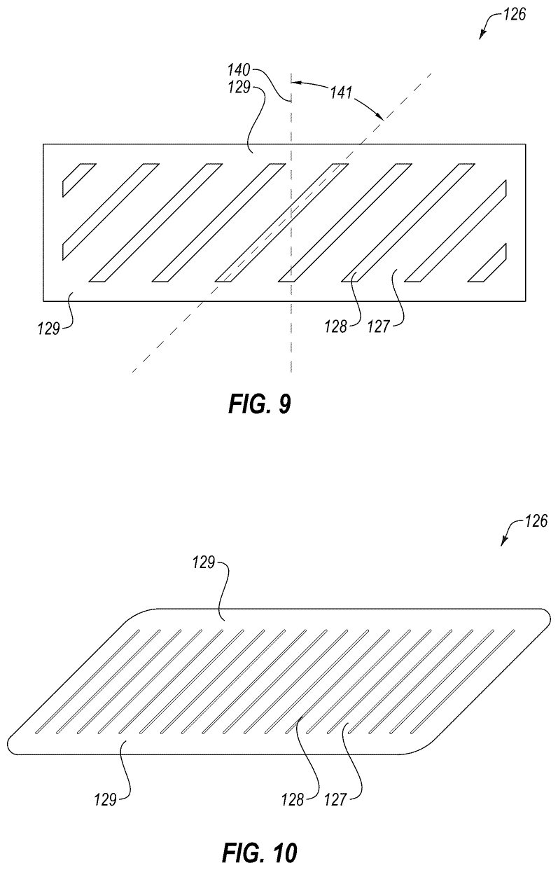

FIG. 9 is a detailed view of the patch 126 of FIG. 8 prior to folding or rolling the patch 126 into a final form, in accordance with one or more embodiments. Referring to FIG. 9, in various embodiments, the patch 126 is formed as a sheet of magnetostrictive metal, bent or rolled into a hollow geometric shape, and joined to the magnet element 121. The various features of the patch 126 (e.g., the tines 127, the inner slots 128, and the magnetic flux guides 129, without limitation) may be formed in the sheet of magnetostrictive metal via a material removal process (e.g., laser ablation, computer numerical control (CNC) micro-milling, water jet cutting, or electron discharge machining, without limitation). Alternatively, the patch 126 (either in a flat form or in a final form) may be additively constructed via an additive manufacturing process (e.g., direct metal printing, direct metal laser sintering, aerosol jet printing, or cold spraying, without limitation). In various embodiments, the patch 126 includes the tines 127, such as between 7 tines and 10 tines 127. The width of the tines 127 may be from 3 times to 5 times the width of the inner slots 128. The magnetic flux guides 129 may form a hollow geometric shape (after being bent or rolled).

FIG. 10 is a detailed view of another configuration of the patch 126 prior to folding or rolling the patch into a final form, in accordance with one or more embodiments. A pattern of the tines 127 and the inner slots 128 may differ from that shown in FIG. 9. For instance, the number and relative dimensions of the tines 127 and the inner slots 128 differ. Referring to FIG. 10, in various embodiments, the patch 126 includes 18-25 tines 127 and the tines 127 are from 5 times to 10 times the width of the inner slots 128.

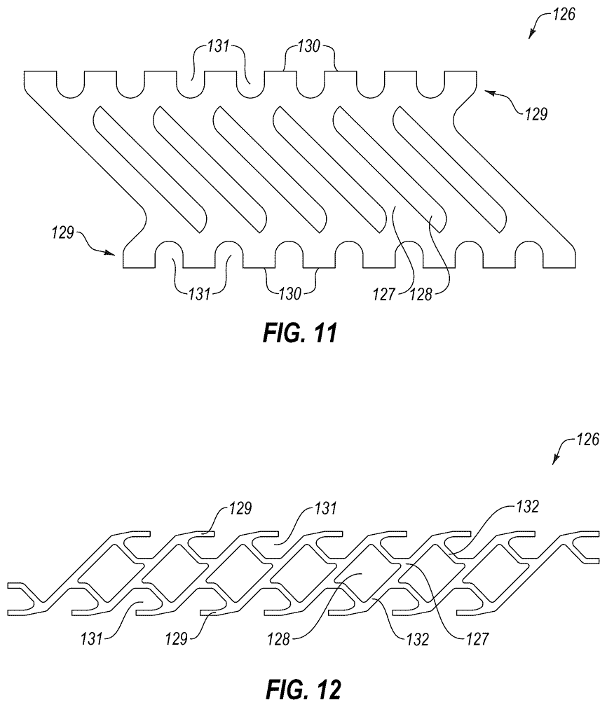

FIG. 11 is a detailed view of another configuration of the patch 126 prior to folding or rolling the patch 126 into a final form, in accordance with one or more embodiments. Referring to FIG. 11, in various embodiments, each magnetic flux guide 129 includes guide segments 130 and end slots 131 separating the guide segments 130. The end slots 131 may extend axially from an end of the patch 126. Each of the guide segments 130 extends in the axial direction and may substantially align with an end of a respective tine 127 of the tines 127 (e.g., aligned sufficiently with the respective tine 127 to turn the magnetic field from a first flux path outside of the patch 126 on entry to a second flux path through the patch 126 and from the second flux path on exit to the first flux path outside of the patch 126, without limitation). The guide segments 130 may be configured to function as a so-called “magnetic yoke” that turns the magnetic field from a first flux path outside of the patch 126 to a second flux path as the magnetic field enters the patch 126 and turns the magnetic field from the second flux path to the first flux path as the magnetic field exits the patch 126. In particular, longitudinal waves may enter the guide segments 130 at a first longitudinal end of the patch 126, may be twisted or sheared to produce torsional waves along the tines 127, and may be straightened by the guide segments 130 at a second longitudinal end of the patch 126.

FIG. 12 is a detailed view of another configuration of the patch 126 prior to folding or rolling the patch 126 into a final form, in accordance with one or more embodiments. Referring to FIG. 12, in various embodiments, the patch 126 includes the tines 127 and joint segments 132 connecting the tines 127. In various embodiments, multiple joint segments 132 connect adjacent tines 127 together (e.g., two joint segments 132, without limitation). In various embodiments, adjacent tines 127 and the joint segments 132 extending therebetween define an inner slot 128 with a substantially rectangular shape. The joint segments 132 may have a width substantially similar to or narrower than the width of the tines 127. The magnetic flux guides 129 may extend from each of the tines 127 and may bend laterally relative to the tines 127 and may extend circumferentially/substantially perpendicular to an axial direction of the patch 126 once the patch 126 is folded/rolled into a final shape thereof.

Referring again to FIGS. 1-5, the controller 102 may send signals to the magnetostrictive ultrasonic transducer 110 and, in particular, to the RF coil 117, lead wires 106, causing one or more ultrasonic waves to be generated. The magnet assembly 120, and in particular, the magnet element 121 and the patch 126 may cause the one or more ultrasonic waves to propagate (e.g., longitudinal waves, torsional waves, flexural waves, shear waves, and/or surface waves, without limitation). The one or more ultrasonic waves may propagate and reflect back to the magnet assembly 120. When the one or more ultrasonic waves passes back over the magnet assembly 120, the RF coil 117 may act as a receiver and send an electrical signal to the controller 102 to facilitate measurement of a time between initially sending the one or more ultrasonic waves and detection or propagation of the one or more ultrasonic waves (e.g., propagation of the ultrasonic wave between a first and a second end of the wave receiving structure 122, without limitation). In various embodiments, the controller 102 is configured to send various types of signals to facilitate formation or different types of ultrasonic waves by the magnetostrictive ultrasonic transducer 110 and/or ultrasonic waves with different properties (e.g., frequency, wavelength, or amplitude, without limitation). The ultrasonic waves may exhibit a range of frequencies (e.g., from about 20 Hz to about 1 MHz, without limitation). Thus, the magnetostrictive ultrasonic transducer 110 may be multi-mode and may be configured to measure multiple types of properties, such as temperature, level, density, and viscosity, and operate in various modes to provide comprehensive data. In various embodiments, the controller 102 is configured to perform one or more of cross-correlation analysis and Coda Wave Interferometry (CWI). CWI may be applied to extract time and frequency variation information. Cross-correlation analysis and CWI may enhance the accuracy and ability to detect minimal changes in both time-domain and frequency-domain signals compared to conventional peak tracking methods. Cross-correlation analysis and CWI may perform well even when the signal-to-noise ratio (S/N) is relatively low.

The controller 102 may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process including operational acts. These acts may be described sequentially. However, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A magnetostrictive ultrasonic transducer, comprising:
a radiofrequency coil; and
a magnet assembly adjacent to the radiofrequency coil and comprising:
a magnet element comprising a first end and a second end, the second end configured to be coupled to a wave receiving structure; and
a magnetostrictive element extending around a portion of the magnet element, offset from the second end, and positioned within the radiofrequency coil, the magnetostrictive element joined to the magnet element and comprising tines extending at an acute angle relative to a longitudinal direction of the magnet assembly.

2. The magnetostrictive ultrasonic transducer of claim 1, wherein the magnetostrictive element is formed of and comprises a magnetostrictive alloy.

3. The magnetostrictive ultrasonic transducer of claim 1, wherein the magnetostrictive element extends around a portion of the magnet element and is joined to the magnet element via a metal fusion process.

4. The magnetostrictive ultrasonic transducer of claim 1, wherein the magnetostrictive element comprises slots separating the tines.

5. The magnetostrictive ultrasonic transducer of claim 1, wherein the magnetostrictive element exhibits a hollow structure chosen from among a hollow right prism and a hollow right circular cylinder.

6. The magnetostrictive ultrasonic transducer of claim 1, wherein the magnetostrictive element comprises magnetic flux guides positioned at opposing ends of the tines.

7. The magnetostrictive ultrasonic transducer of claim 6, wherein each of the magnetic flux guides exhibits a hollow geometric shape.

8. The magnetostrictive ultrasonic transducer of claim 7, wherein each of the magnetic flux guides comprises end slots formed therein, the end slots extending axially from an end of the magnetostrictive element toward the tines, the end slots defining guide segments substantially aligned with an end of a respective one of the tines.

9. The magnetostrictive ultrasonic transducer of claim 1, wherein the magnet assembly comprises the wave receiving structure, the wave receiving structure comprising a waveguide permanently coupled to the second end of the magnet element.

10. A magnet assembly for a magnetostrictive ultrasonic transducer, the magnet assembly comprising:
a waveguide;
a magnet element joined to and extending from the waveguide; and
a magnetostrictive element extending around a portion of the magnet element, offset from the waveguide, the magnetostrictive element joined to the magnet element and comprising tines extending at an acute angle relative to a longitudinal direction of the magnet element.

11. The magnet assembly of claim 10, wherein the waveguide comprises a connection portion and a guide portion extending from the connection portion, the connection portion coupled to the magnet element and the guide portion configured to propagate waves.

12. The magnet assembly of claim 10, wherein the magnetostrictive element comprises a hollow structure chosen from among a hollow right prism and a hollow right circular cylinder, each end of the hollow geometric shape comprises a solid hollow structure defining a magnetic flux guide.

13. The magnet assembly of claim 12, wherein the magnetostrictive element comprises slots formed therein and extending between the solid hollow structure of each end of the magnetostrictive element, the slots defining the tines.

14. The magnet assembly of claim 12, wherein the magnetostrictive element is positioned closer to an end of the magnet element distal to the waveguide than an end coupled to the waveguide.

15. The magnet assembly of claim 10, wherein an individual one of the tines comprises a respective magnetic flux guide extending from ends thereof.

16. A measurement system comprising:
a magnetostrictive ultrasonic transducer comprising:
a coil assembly configured to transmit and receive signals, the coil assembly comprising:
a coil bobbin comprising a bore formed therein; and
a radiofrequency coil on the coil bobbin; and
a magnet assembly comprising:
a magnet element comprising a first end and a second end, the second end configured to be coupled to a wave receiving structure; and
a magnetostrictive element extending around a portion of the magnet element, offset from the second end, and positioned within the bore of the coil bobbin, the magnetostrictive element comprising tines extending at an acute angle relative to a longitudinal direction of the magnet assembly;
a controller configured to:
send input signals to the radiofrequency coil to cause the magnetostrictive ultrasonic transducer to generate one or more ultrasonic waves;
receive output signals from the magnetostrictive ultrasonic transducer; and
process the output signals to determine one or more properties of a fluid or structure.

17. The measurement system of claim 16, wherein the radiofrequency coil is centered over a center of the magnetostrictive element.

18. The measurement system of claim 16, wherein the acute angle is from about 15 degrees to about 50 degrees.

19. The measurement system of claim 16, wherein the magnet assembly comprises the wave receiving structure, the wave receiving structure comprising a waveguide axially protruding from the coil assembly.

20. The measurement system of claim 16, wherein the magnetostrictive ultrasonic transducer comprises a casing with the coil assembly received therein, and wherein the coil bobbin comprises coil formers, one of the coil formers comprising one or more routing features formed therein and defining a channel extending axially across the coil former, the one or more routing features configured to receive ends of lead wires to facilitate connecting the ends of the lead wires to the radiofrequency coil.
